(19) United States
(12) Patent Application Publication
(10) Pub. No.: US 2007/0205310 A1
(43) Pub. Date: Sep. 6, 2007

(54) Shower Head for Kitchen Sink

(76) Inventor: Huasong Zhou, Xiamen, Fujian (CN)

Correspondence Address: BANGER SHIA, 204 CANYON CREEK, VICTORIA, TX, 77901-3695, US

(21) Appl. No.: 11/307,987

(22) Filed: Mar. 1, 2006

(51) Int. Cl. B05B 15/08

(52) U.S. Cl. 239/587.1; 239/587.3; 239/587.4

(57) ABSTRACT

The present invention provides a shower head for kitchen sink, which is typically comprised of an inlet adapter, a pivot ball adapter, a bell shade, a spraying assembly and outlet panel; wherein, said inlet adapter is connected to the inlet pipe with the top end, and covers over the top portion of the bell shade; said bell shade has a hollow housing downward for holding an inner collar having a spherical groove in, the assembly of the bell shade and the inner collar has a through-hole at the top end; said pivot ball adapter has a piping segment built upon the top side, and is mounted into the bell shade and the inner collar from the down to up so that the piping segment passes through the through-hole to connect to the inlet adapter, the ball head is mated into the spherical groove of the inner collar, there are O-rings sealing over the contacting surfaces of the matched ball head and the spherical groove of the collar; said spraying assembly is mounted into the hollow inside of the housing; said outlet panel is covered over the opening of the ball shade. Above-mentioned structure can make the located shower head adjust the spraying water orientation in a certain range at will, and facilitate to using.

### BACKGROUND OF THE INVENTION

1. Field of the Invention

The present invention relates to a shower head for kitchen sink, and more particularly to a swiveled shower head with ball joint structure facilitating to adjusting the shooting orient in kitchen sink.

2. Description of Prior Art

In accordance with the conventional technology, the shower head located on the side of the kitchen sink can be adjusted to spray water horizontally just as crossing the handle, if tending to change the spraying orientation of water, have to take off the shower head operating with hand directly and inconveniently. For resolving these problems, the U.S. Pat. Nos. 5,398,872 and 5,704,547 discovered adjustable shower heads, in which a ball-socket coupling is attached on for connecting the shower head to the inlet pipe, by means of the matched ball joint between the shower head and the inlet, the shower head can swivel round the inlet facilitating to adjusting the spraying angle, because there is not any spacing mechanism in there, the shower head can be tilted in a big range about 100 degrees, so that the ball-socket coupling is easy to slip with applying force as adjusting the spraying orientation, to generate a moment round the axel of the ball joint unexpectedly to change the shot water in the big amplitude, the mistake operation is greatly to affect the use effect. But, in the kitchen, the wet and dry ranges are seriously separated, like the top of the kitchen range and cooking stove are absolutely to avoid splashing water, if not, the cleaning work is increased, the more danger coming from dieing out the flame occur the gas escape out into the air. Therefore, the above both inventions are not applied into kitchen sink so far yet.

### OBJECTS AND SUMMARY OF THE INVENTION

It is therefore a main object of the present invention to provide a shower head for kitchen sink facilitating to adjusting the spraying water orientation in a certain range at will, and operating without mistake happened. For achieving the above-mentioned object, the present invention provides a shower head for kitchen sink typically comprised of an inlet adapter, a pivot ball adapter, a bell shade, a spraying assembly and outlet panel; wherein, said inlet adapter is connected to the inlet pipe with the top end, and covers over the top portion of the bell shade; said bell shade has a hollow housing downward for holding an inner collar having a spherical groove in, the assembly of the bell shade and the inner collar has a through-hole at the top end; said pivot ball adapter has a piping segment built upon the top side, and is mounted into the bell shade and the inner collar from the down to up so that the piping segment passes through the through-hole to connect to the inlet adapter, the ball head is mated into the spherical groove of the inner collar, there are O-rings sealing over the contacting surfaces of the matched ball head and the spherical groove of the collar; said spraying assembly is mounted into the hollow inside of the housing; said outlet panel is covered over the opening of the ball shade. Said inlet adapter extends out a skirt out-downward covering over said bell shade. As utilizing above-mentioned project, the present invention is secured on the inlet pipe with inlet adapter. As using, it not only can do as the prior art, by means of the spraying assembly switch to spraying water horizontally, but also by means of two matching curved surfaces: such as the inlet adapter and the top portion of the bell shade, and the ball head of the pivot ball adapter and the spherical groove of the inner collar, the bell shade can swivel in the certain range (about 20 degrees in design) at will, so that the spraying water orientation can be changed accurately into the desired facilitating to using, and the spacing function comes from constraint of the matching curved surfaces of the inlet adapter and the top portion of the bell shade, so the certain swiveling range of the shower head depends on the matching level.

### BRIEF DESCRIPTION OF THE DRAWINGS

FIG. 1 is a cross-section view of the present invention.

### DETAILED DESCRIPTION OF PREFERRED EMBODIMENTS

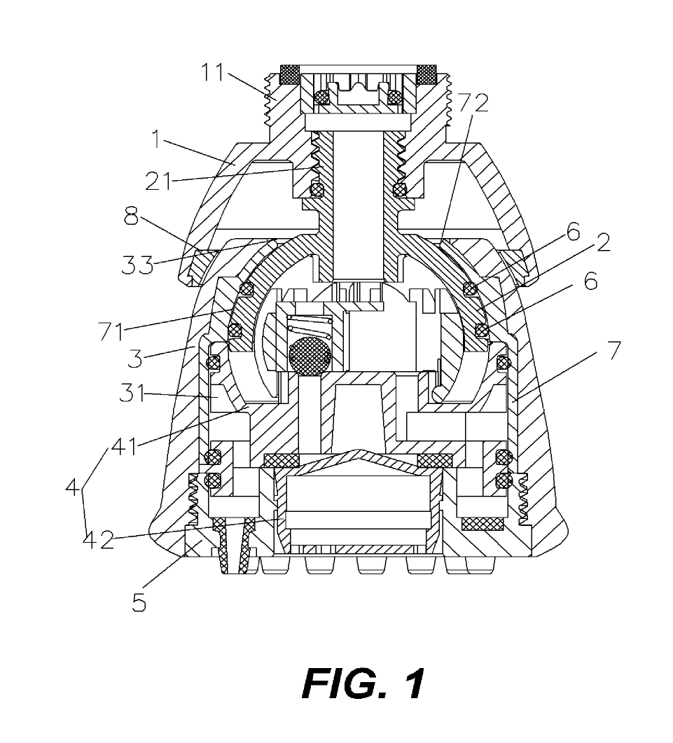

Referring to FIG. 1, a shower head for kitchen sink discovered by the present invention is typically comprised of an inlet adapter 1, a pivot ball adapter 2, a bell shade 3, a spraying assembly 4 and an outlet panel 5. Said inlet adapter 1 has a piping segment 11 used for connecting to the inlet pipe (not shown in drawings) and a skirt extended out for covering over the top portion of the bell shade 3. Said bell shade 3 has a hollow housing 31 with an opening downward for holding an inner collar 7 having a spherical groove 71 in, the assembly of the bell shade 3 and the inner collar 7 has a through-hole 33 72 at the top end, building the inner collar 7 on just divides water from the galvanized surface of the bell shade 3 for guaranteeing to pass through NSF certification, for increasing the wear-ability, decreasing the friction and facilitating to adjusting, the inner collar 7 is make of acetal resin. Said pivot ball adapter 2 has a piping segment 21 built upon the top side, and is mounted into the bell shade 3 and the inner collar 7 from the down to up so that the piping segment 21 passes through the through-hole 33 72 to connect to the inlet adapter 1, the ball head is mated into the spherical groove 71 of the inner collar 7, there are O-rings 6 sealing over the contacting surfaces of the matched ball head 2 and the spherical groove 71 of the collar 7. Said spraying assembly 4 is mounted into the housing 31. Said spraying assembly 4 is as same as the conventional technology, so it is not in the claimed range of the present invention, and the detail of it will be not described here. In the embodiment, the spraying assembly 4 includes hydro-separator 41 and foaming device 42, and so on. Said outlet panel 5 is covered over the opening of the housing 31. All the matching surfaces of the adjacent components should be sealed with O-rings; it will be not stressed again. For increasing the wear-ability, decreasing the friction and facilitating to adjusting, a bushing ring 8 is built upon the contacting portion between the inlet adapter 1 and the top portion of the bell shade 3, in which said bushing ring 8 is made of acetal resin. In this case, the present invention is secured on the inlet pipe with the pipe segment 11 of the inlet adapter 1. As using, it not only can be done all the features of the prior art, by means of the spraying assembly switch to spraying water horizontally, but also by means of two matching curved surfaces: such as the inlet adapter 1 and the top portion of the bell shade 3, and the ball head of the pivot ball adapter and the spherical groove 71 of the inner collar 7, the bell shade 3 can swivel in the certain range (about 20 degrees in design) round the inlet pipe at will, so that the spraying water orientation can be changed accurately into the desired facilitating to using, and getting better spraying effect. The spacing function comes from constraint of the matching curved surfaces of the inlet adapter 1 and the top portion of the bell shade 3, so the certain swiveling range of the shower head depends on the matching level, therefore, the spraying water orientation can be changed accurately into the desired at will facilitating to using, and getting better spraying effect.

What is claimed is:

1. A shower head for kitchen sink typically comprised of an inlet adapter, a pivot ball adapter, a bell shade, a spraying assembly and outlet panel; wherein, said inlet adapter is connected to the inlet pipe with the top end, and covers over the top portion of the bell shade; said bell shade has a hollow housing downward for holding an inner collar having a spherical groove in, the assembly of the bell shade and the inner collar has a through-hole at the top end; said pivot ball adapter has a piping segment built upon the top side, and is mounted into the bell shade and the inner collar from the down to up so that the piping segment passes through the through-hole to connect to the inlet adapter, the ball head is mated into the spherical groove of the inner collar, there are O-rings sealing over the contacting surfaces of the matched ball head and the spherical groove of the collar; said spraying assembly is mounted into the hollow inside of the housing; said outlet panel is covered over the opening of the ball shade.

2. A shower head for kitchen sink typically comprised of an inlet adapter, a pivot ball adapter, a bell shade, a spraying assembly and outlet panel; wherein, said inlet adapter is connected to the inlet pipe with the top end, and covers over the top portion of the bell shade, said inlet adapter extends out a skirt out-downward; said bell shade has a hollow housing downward for holding an inner collar having a spherical groove in, the assembly of the bell shade and the inner collar has a through-hole at the top end; said pivot ball adapter has a piping segment built upon the top side, and is mounted into the bell shade and the inner collar from the down to up so that the piping segment passes through the through-hole to connect to the inlet adapter, the ball head is mated into the spherical groove of the inner collar, there are O-rings sealing over the contacting surfaces of the matched ball head and the spherical groove of the collar; said spraying assembly is mounted into the hollow inside of the housing; said outlet panel is covered over the opening of the ball shade.
